(19) United States
(12) Patent Application Publication
(10) Pub. No.: US 2005/0262620 A1
(43) Pub. Date: Dec. 1, 2005

(54) Protective garment system having activated carbon composite with improved adsorbency

(76) Inventors: Shulong Li, Spartanburg, SC (US); Xinggao Fang, Duncan, SC (US); Zeb W. Atkinson, Boiling Springs, SC (US); Nathan B. Emery, Spartanburg, SC (US); Julie A.O. Smallfield, Woodruff, SC (US); Edwin R. Lee, Gaffney, SC (US)

Correspondence Address: Milliken & Company, P. O. Box 1927, Spartanburg, SC, 29304, US

(21) Appl. No.: 10/853,945

(22) Filed: May 26, 2004

(51) Int. Cl. B32B 3/00

(52) U.S. Cl. 2/455

(57) ABSTRACT

The present disclosure relates to a protective garment system having two primary components. The first component, which serves as the outer layer of the garment, comprises a textile substrate that has been treated on one side with a hydrophobic composition and has been treated on the opposite side with an oleophobic composition. This combination is well-suited for protection against a variety of organic, oily type liquids (such as chemical warfare agents). The second component, which is a composite structure that serves as the inner layer of the garment, contains a core of activated carbon positioned between layers of adhesive and textile substrate.

### TECHNICAL FIELD

The present disclosure relates to a protective garment system that includes an outer layer treated to have both hydrophobic and oleophobic surfaces and an inner layer made of an activated carbon composite. Such a garment provides effective protection against a variety of contaminants, including organic oily chemical compounds.

### BACKGROUND

Activated carbon comes in a variety of forms. Initially, it was made in the form of granules or powder. More recently, it has been made in the form of a fabric known as charcoal cloth or carbon cloth. Activated carbon is used to adsorb undesirable components from the atmosphere or from a local environment. However, it is known that the effectiveness of activated carbon can be comprised by other components, not necessarily undesirable per se, that saturate the activated carbon and prevent it from adsorbing the undesirable components. The most common component that leads to such saturation of activated carbon is water.

Activated carbon is used in clothing to provide protection against undesirable components, but when such clothing is wet, the effectiveness of the activated carbon in adsorbing the undesirable component is drastically reduced. Also, the additional weight of such wet clothing presents a further disadvantage. To overcome this problem, activated carbon is often used as one component in a composite structure that includes at least one relatively waterproof fabric layer in contact with the activated carbon. It is common for the outer layer of the composite structure to be treated with a hydrophobic finish repel water.

There is a problem associated with using such a waterproof barrier fabric as either the outer layer of an activated carbon composite, the inner layer of such a composite, or both. Because the barrier fabric cannot prevent moisture condensation on the activated carbon, liquids (e.g, sweat or water) can reach the activated carbon and inhibit its adsorption ability. Once the moisture has condensed on the surface of the activated carbon, the barrier fabric actually traps the moisture on the activated carbon, preventing evaporation. The so-called barrier fabrics are especially incapable of performing their intended role—that is, preserving the adsorptive properties of the activated carbon—in the laundering process, where the composite is exposed not only to large amounts of water, but also to detergents, soil, and other contaminants.

Accordingly, there is a clear need for a protective garment system containing an activated carbon inner layer that is durable with respect to multiple launderings and that is capable of maintaining practical levels of adsorption over time, and further containing a protective outer layer that includes a textile substrate with hydrophobic and oleophobic properties.

### SUMMARY

The present disclosure relates to a protective garment system having two primary components. The first component, which serves as the outer layer of the garment, comprises a textile substrate that has been treated on one side with a hydrophobic composition and has been treated on the opposite side with an oleophobic composition. This combination is well-suited for protection against a variety of organic, oily type liquids (such as chemical warfare agents). The second component, which is a composite structure that serves as the inner layer of the garment, contains a core of activated carbon positioned between layers of adhesive and textile substrate.

### BRIEF DESCRIPTION OF THE DRAWINGS

FIG. 1 is a schematic cross-sectional view of a first embodiment of the present protective garment system;

FIG. 2 is a schematic cross-sectional view of a second embodiment of the present protective garment system; and

FIG. 3 is a schematic cross-sectional view of a third embodiment of the present protective garment system.

### DETAILED DESCRIPTION

Disclosures relating to the preparation of carbonized and active carbon yarns and fabrics and the utilization thereof in protective clothing of various types to serve as protection against various hazards may be found in U.S. Pat. No. 3,235,323 to Peters; U.S. Pat. No. 3,256,206 to Doying; U.S. Pat. No. 3,556,712 to Dickson et al.; U.S. Pat. No. 3,639,140 to Miyamichi; U.S. Pat. No. 3,744,534 to Henry et al.; U.S. Pat. 3,769,144 to Economy et al.; U.S. Pat. No. 3,850,785 to McQuade et al; and others. The above list is intended to be representative and should not be taken as a complete list of patents relating to carbon fabrics or processes by which they may be produced.

Turning now to the FIGURES, identical numbers are used throughout to represent items of the same or similar structure.

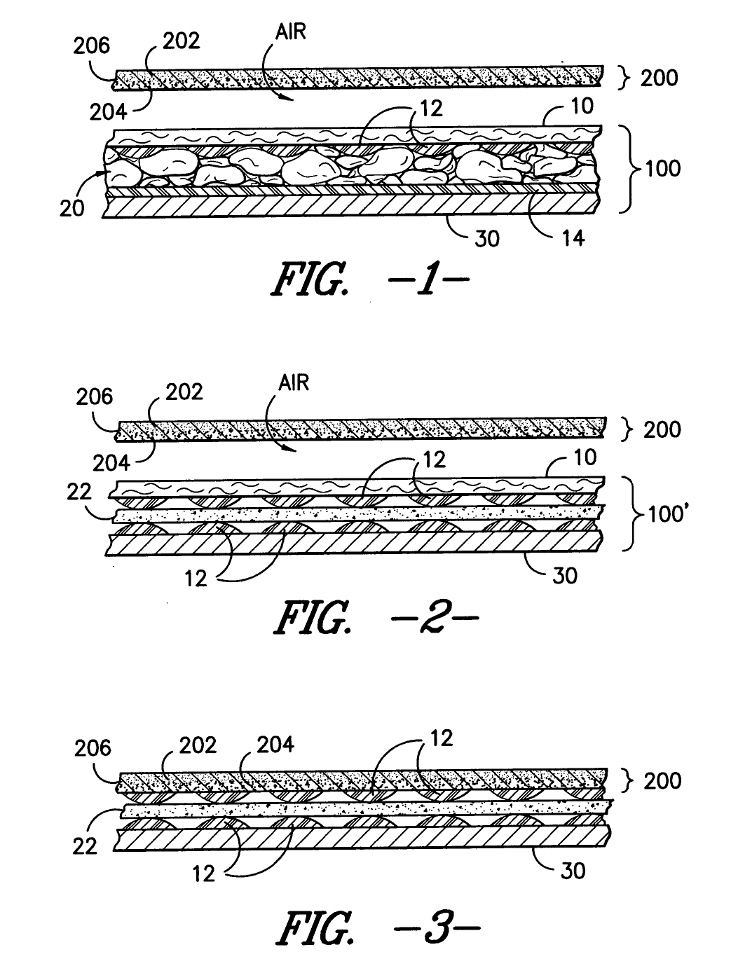

FIG. 1 shows a first embodiment of the protective garment system of the present disclosure. A treated textile substrate 200, which is shown at the top of the illustration, serves as the outer layer of the protective garment system. Textile substrate 200 has been treated, as will be described, to have at least one side that is hydrophobic and a side that is primarily oleophobic. Schematically, surface 202 represents the hydrophobic side, while surface 204 represents the primarily oleophobic side. Between surface 202, 204 is believed to be a transition zone 206 in which both the hydrophobic and oleophobic compositions may be present. The depth of either the hydrophobic or oleophobic compositions may be controlled by processing conditions; therefore, the illustration is intended to be representative only of the dual surface treatments and should not be viewed as indicative of their various levels.

Treated textile substrate 200 described herein is used as an outer layer for a protective garment, which is used in connection with an inner layer that contains activated carbon. A first treatment applied to a textile substrate provides a hydrophobic surface to what will eventually become the outer surface of the garment. The hydrophobic surface 202 repels water from the garment, thereby protecting the activated carbon 20 from liquid contamination.

Further, oily compounds are absorbed by the hydrophobic surface 202 of the treated textile substrate 200. However, because the opposite side (that is, surface 204) of the textile substrate is oleophobic, oily compounds cannot pass through textile substrate 200. The oily compound is instead spread across, and absorbed into, textile substrate 200. By dispersing the oily compound over a larger surface area on textile substrate 200, the vapors of the oily compound are similarly diffused over a larger surface area of activated carbon 20 present in the inner layer 100 of the protective garment.

Although intended for use in protective apparel for the military (where the oily compound may be a nerve agent), it is anticipated that the treated textile could also be used in aprons; protective apparel for chemical, industrial, and food service applications; and textile wipes for a variety of purposes.

The method used to create the dual surface treatments will now be described. A textile substrate is constructed from natural or synthetic fibers, filaments, or yarns, or blends thereof. For example, the textile substrate may be comprised of fibers or yarns made from commonly available materials such as nylon, polyester, polypropylene, acrylic, olefins such as polyethylene and polypropylene, cellulosic materials (e.g., rayon or cotton), blends thereof, and other materials having a synthetic or natural construction. It should be understood that the discussion of any specific polymer herein is intended to include not only homopolymers, but also co-polymers thereof.

The selected yarn (or yarns, if different types are used) optionally may be dyed, as where accent yarns in the final product are desired or where yarns particularly suited to solution dyeing (e.g., polypropylene) are used. The yarns may be textured or untextured, depending on the desired appearance of the treated textile product.

Possible constructions of the textile substrate include various types of weaving and knitting, as well as the use of non-woven constructions. Textile substrate can be printed or dyed before application of the treatments described herein. In addition, textile substrate can be treated mechanically (such as by sanding or brushing) to create a surface that mimics those of leaves, such as lotus or rice.

The water repellent property of treated textile substrate 200 is created by the application of one or more hydrophobic finishes, such as waxes, silicones, and acrylic copolymers. Examples of waxes suitable for use in this application include a zirconium wax sold by Consols Inc. of Charlotte, N.C., under the tradename CONSOPEL ZW; an aluminum wax sold by Cognis of Cincinnati, Ohio, under the tradename REPELLAN HY-N; a wax sold by Rudolf-Venture Chemical of Rock Hill, S.C., under the tradename RUCO-DRY DHY; a wax sold by Noveon, Inc. of Cleveland, Ohio, under the tradename FREEPEL 1225. Of these, FREEPEL 1225 wax has been found to work particularly well. One example of an acrylic copolymer suitable for use in this application is an acrylic copolymer sold by Rohm & Haas of Spring House, Pa., under the tradename EMULSION E-940. One example of a silicone suitable for use in this application is a silicone sold by Kelmar Industries of Duncan, S.C., under the tradename FINISH WS 60E.

The hydrophobic finish (shown schematically as surface 202) is applied to one or both sides of the textile substrate, using application methods such as padding, coating, spraying, and foam coating. Foam coating is generally preferred because of the ability to control the level of add-on and depth of penetration. The hydrophobic finish is applied at add-on levels in the range of between about 1% and about 20% based on the weight of the untreated textile substrate and, more preferably, between about 1% and about 10%.

To one side of the textile substrate, an oleophobic finish is applied (represented schematically by surface 204). Fluorochemicals are particularly good at providing oleophobic properties to the textile substrate. Examples of such fluorochemicals include a fluorochemical sold by Ciba Specialty Chemical of High Point, N.C., under the tradename ZONYL 7713; fluorochemicals sold by Mitsubishi International Corporation of New York, N.Y. under the tradenames REPEARL F35 and REPEARL F7000; fluorochemicals sold by Daikin America Corporation of Mobile, Ala., under the tradenames UNIDYNE TG571 and UNIDYNE TG470. Of these, REPEARL F35 fluorochemical has been found to work particularly well. Alternatively, the oleophobic finish can be created by the application of oleophobic microporous materials, such as TEFLON® films, to the textile substrate. In this instance, that is, the use of microporous oleophobic films, the treated textile 200 would be breathable. Lastly, the oleophobic surface could be calendered to offer increased resistance to oil penetration.

The oleophobic finish is applied to only one side of the textile substrate (that is, surface 204), using application methods as were described above. The oleophobic finish is applied at add-on levels in the range of between about 0.1% and about 20% of the weight of untreated textile substrate and, more preferably, between about 0.5% and about 10% of the weight of the untreated textile substrate.

One application method is to apply the hydrophobic treatment to one side of the textile substrate (surface 202), followed by application of the oleophobic treatment (to surface 204). Another technique is to apply the hydrophobic and oleophobic treatment simultaneously, using, for example, a two-sided foam coater.

Crosslinking agents, such as epoxides, melamines, and blocked isocyanates, can be incorporated into either of the finishes to increase their wash durability. Crosslinking agents are generally added at levels of between about 0.01% to about 10% of the weight of the textile substrate and, more prefereably, between about 0.05% to about 5%. Further, small particulates (such as nanoparticles) could be applied to the textile substrate to create a certain physical structure, either before the substrate is treated as described herein or as part of the treatment. Such structure may enhance the hydrophobic surface properties of textile substrate 200.

In addition, small amounts of oleophobic fluorochemicals can be included in the hydrophobic formulation to increase the durability of the hydrophobic properties to laundering and to adjust the repellency properties of treated substrate 200. Typically, the amount of oleophobic material added is at levels of between about 0.02% to about 5% of the weight of the untreated textile substrate.

Likewise, adding hydrophobic components to the oleophobic finish allows the manufacturer to adjust the repellency and durability of treated textile substrate 200. Typically, the amount of hydrophobic material added is at levels of between about 0.1% to about 10% of the weight of the untreated textile substrate.

Once the finishes have been applied to the textile substrate, treated textile substrate 200 is dried for between 30 seconds and ten minutes in an oven at temperatures between about 250° F. and 400° F.

Treated textile substrate 200 has good water repellency and good oil absorbency and pass-through resistance, all of which are durable to laundering. Accordingly, treated textile substrate 200 represents an advance over previous outer layer components having only a hydrophobic finish.

Turning now to the lower portion of FIG. 1 that represents the inner layer of a protective garment system, a composite structure 100 is shown in which a plurality of non-spherically shaped, non-uniformly sized activated carbon granules are secured between layers of adhesive (12, 14) and textile substrate (10, 30).

Composite 100 includes a layer of non-spherically activated carbon granules 20 that are positioned between two layers of textile substrates 10, 30. Carbon granules 20 are secured, relative to textile substrate 30, by a substantially continuous layer of adhesive 14. Carbon granules 20 may be further secured, relative to textile substrate 10, by discontinuous adhesive layer 12 formed by a plurality of spaced adhesive dots. Although a continuous (or a substantially continuous) layer of adhesive could also be employed for this purpose, the use of adhesive dots imparts enhanced flexibility to the finished composite 100. Having generally described the components of, and the structure of, composite 100, each component will now be described in more detail.

Textile substrates 10, 30 are constructed from synthetic fibers, filaments, or yarns. For example, textile substrates 10, 30 may be comprised of fibers or yarns made from commonly available materials such as nylon, polyester, polypropylene, acrylic, olefins such as polyethylene and polypropylene, polyaramid (e.g., Nomex® or Kevlar®), and other materials having a synthetic construction. It should be understood that the discussion of any specific polymer herein is intended to include not only homopolymers, but also co-polymers thereof.

Possible constructions of the textile substrate include various types of weaving and knitting, as well as the use of non-woven constructions. The textile substrate can be printed or dyed before application of the repellent treatment described herein. In addition, one or more of the textile substrates can be subjected to surface finishing procedures, such as brushing, sanding, or napping before application of the repellent treatment. It is preferred that at least one of the textile substrates 10, 30 is dyed black or another dark color to avoid poor appearance that may result from staining or from show-through of activated carbon granules 20.

In one embodiment, textile substrate 30 is a tricot knit polyester fabric, with a weight of about 2.3 oz/yd², which has been brushed on one side. It is contemplated that adhesive layer 14 is preferably applied to the brushed side of textile substrate 30. Also present in the preferred embodiment, textile substrate 10 is a nonwoven fabric. Representative examples of suitable nonwoven fabrics include a powder-bonded polyester nonwoven textile, which contains some polyester adhesive and has a weight of about 0.9 oz/yd² and a point-bonded nonwoven fabric containing polyester, nylon, and combinations thereof. In circumstances where composite 100 is being used as a garment, or as a part of a garment, it is contemplated that the knit fabric (in this case, textile substrate 30) would be the side contacting the wearer of the garment. Preferably, textile substrates 30 have a weight in the range of about 1.8 oz/yd² to about 3.0 oz/yd², while textile substrates 10 have a weight in the range of about 0.5 oz/yd² to about 2.0 oz/yd².

Adhesive layers 12, 14 suitable for this invention are comprised of one or more of the class of polymeric resins with good adhesive strength, laundry resistance, and flexibility. Suitable resins include copolyamides (such as nylon 6 and nylon 12 copolymers), polyurethane, aliphatic polyesters, polyacrylics, ethylene vinyl acetate copolymers, epoxies, and the like. Of these, copolyamides and polyurethane are preferred. The same adhesive material can be used for adhesive layers 12, 14, or different adhesive materials may be used for each layer. The adhesive layer is preferably present at a weight of 0.2 oz/yd² to 3 oz/yd², and more preferably in the range of 0.5 oz/yd² to 1 oz/yd² for each of the layers.

Preferably, adhesive layer 14 is a substantially continuous layer of adhesive material to provide uniform bonding between activated carbon granules 20 and textile substrate 30. Adhesive layer 14 may be applied by transfer coating, knife-coating, foam coating, roll coating, slot die coating, or other methods as are known in the art. Adhesive layer 14 comprises a plurality of tiny adhesive particles (typically on the order of 40 to 60 microns in size) that are in close proximity to each other when applied as a foam or a paste. Unlike a polymeric film, for example, the tiny, particles provide more flexibility to composite 100, and they further greatly increase the air permeability of composite 100 (when compared to the air permeability of a film).

In one embodiment, adhesive layer 12 is a discontinuous layer of adhesive material. The discontinuous nature of adhesive layer 12 enables composite 100 to have enhanced flexibility for use as part of a garment. Layer 12 can be formed from a plurality of dots of optional shapes (e.g., circular, square, elliptical, etc.) applied in a spaced, patternwise arrangement over one surface of textile substrate 10. Although dots are preferred, other configurations could also be used, including stripes, curlicues, broken lines, and the like. In an alternate embodiment, adhesive layer 12 could be a substantially continuous layer that is formed by scattered powder coating, foam coating, paste coating, and the like.

The core of composite 100 is comprised of activated carbon granules 20 that are capable of adsorbing liquid and gas molecules from chemical and biological hazards (that is, such molecules adhere to the surfaces of such granules). Such carbon granules 20 are present within composite 100 at a weight of about 1 oz/yd² to 10 oz/yd², and preferably 4 oz/yd² to 7 oz/yd². The non-spherical activated carbon granules 20 may be made from coconut starting material to provide resistance to crushing of the granules. This particular type of activated carbon, having size and hardness characteristics that will be discussed below, exhibits a micro-porous structure that is especially well suited for effective gas phase adsorption.

The preferred surface area parameters will be discussed in further detail herein. It should be noted that the adsorbency of carbon granules 20 is directly related to pore size. If the pores are too small, relative to the molecules of hazardous materials being adsorbed, carbon granules 20 will lack sufficient surface area for adequate adsorption. If the pores are too large, relative to the molecules of hazardous materials being adsorbed, carbon granules 20 will be less effective at adsorption. For instance, if the pores are large, gas molecules are able to pass through them without being adsorbed.

Preferably, carbon granules 20 have a hardness of at least 90% and, more preferably, 95% or greater, as determined by ASTM Test Method D3802-79, “Standard Test Method for Ball-Pan Hardness of Activated Carbon.” This level of hardness prevents carbon granules 20 from being crushed or broken during ordinary use of a protective garment made from composite 100.

Besides hardness, another important feature of carbon granules 20 is their size and shape. The size and shape of carbon granules 20 contributes to the surface area available for adsorbing chemical or biological agents. Preferably, carbon granules 20 have sizes in the range of 12 to 80 US Mesh and, more preferably, in the range of 20 to 50 US Mesh. In particular, carbon granules 20, as used herein, have a non-uniform size and a non-spherical shape, characterized by the presence of granules of various sizes and shapes.

Carbon granules 20 exhibit a surface area of at least 1000 m²/g and, more preferably, of at least 1300 m²/g, as measured using the Brunauer-Emmett-Teller (BET) model of physical adsorption, where nitrogen is the adsorbed substance. Another means for evaluating the adsorptive capacity of the activated carbon granules is ASTM D4607-94, “Standard Test Method for Determination of Iodine Number of Activated Carbon.” When measured by ASTM D4607-94, the iodine number of the activated carbon granules is at least 1000 mg/g and, more preferably, at least 1300 mg/g.

To make composite 100, adhesive layer 14 may be applied to textile substrate 30 by coating, extruding, spraying, foam coating, powder scattering coating, printing, or laminating, or other suitable processes known to one of ordinary skill in the art. Activated carbon granules 20 are then applied by static powder scattering head, powder spraying apparatus, or other similar means to adhesive layer 14. The non-uniformity of the size of carbon granules 20 permits the random orientation and close packing of carbon granules 20 on continuous adhesive layer 14 attached to textile substrate 30, which provides exceptionally higher surface area and less void spaces between activated carbon granules 20, a feature not presently achievable with spherical carbon granules that have a relatively uniform size and that are typically applied to discontinuous adhesive dots.

Textile substrate 10, to which has been applied a spaced patternwise arrangement of adhesive layer 12, is subsequently disposed over the layer of activated carbon granules 20, with adhesive layer 12 positioned against activated carbon granules 20. The various layers are then pressed together at temperatures between about 70° C. and about 250° C. for a period of time sufficient to activate adhesive layers 12, 14 (typically, between 10 and 45 seconds and, more preferably, between 15 and 30 seconds). The resulting composite (100) is then cooled to room temperature before further processing.

Optionally, composite 100 is impregnated with a water repellent and oil repellent fluorocarbon emulsion or solution to render the whole composite, including the activated carbon layer, water- and oil-repellent. The impregnation process can be achieved by dipping the composite in a fluorocarbon resin emulsion or solution or by spraying the fluorocarbon liquid on the composite, followed by drying. A wash-durable repellent formulation containing a cross-linking agent, such as a polyisocyanate compound, is preferred. Such a formulation is applied at a level in the range of about 0.1% to about 8% of the weight of the composite and, more preferably, in the range of about 0.5% to about 2% of the weight of the composite. The fluorocarbon-impregnated composite resists contamination of the activated carbon layer by sweat, rain, seawater, fuels, and other liquids.

Treated textile substrate 200 and composite 100 are positioned, with respect to one another, as shown in FIG. 1, and are sewn at least at their respective end portions. Conceivably, there may be other joining points as well, as may be needed to accommodate the shape of the intended wearer.

Hydrophobic surface 202 of textile substrate 200 is the outermost layer of the protective garment system as described herein. Oleophobic surface 204 is positioned toward composite 100. In this embodiment, a layer of air is disposed between oleophobic surface 204 and composite 100. The air layer will undoubtedly be of various dimensions across the protective garment system (that is, it will be thinner at areas where substrate 200 and composite 100 are joined and at areas where the outer surface of the garment is in contact with another object).

Turning now to FIG. 2, a second embodiment of the protective garment system is shown. In this embodiment, treated textile substrate 200 is the same as that shown and described in FIG. 1. Composite 100 has been replaced with composite 100′, in which a treated carbon cloth 22 is used instead of carbon granules 20. Treated carbon cloth 22 is prepared as described below.

The treatment comprises impregnating or coating the activated carbon with fluorocarbon compounds that effectively modify the surface energy of the carbon material. Suitable fluorocarbons include those that dry to form a water- and oil-repellent film at temperatures below about 300° C. and, more preferably, at temperatures below about 200° C. The fluorocarbon compounds are preferably copolymer resins containing a monomer with a C₄ to C₂₄ perfluoro-alkyl radical and a non-fluorinated monomer. Examples include copolymers containing perfluorinated C₈ acrylate monomer and alkyl acrylates, and polyurethanes containing C₈ perfluoroalkyl radicals.

The fluorocarbon compounds can be applied to the activated carbon as an emulsion or solution by spraying, immersion, or fluidized bed application, each of which is followed by a drying step. The fluorocarbon compounds are present at add-on weights of 5% or less and, more preferably, 3% or less, where percentages are based on the weight of the activated carbon. Even at add-on levels of as low as 0.1% of the weight of the activated carbon, the fluorocarbon treatment has been found effective. Preferably, add-on weights are in the range between about 0.1% and 5% of the weight of the activated carbon and, more preferably, between about 0.1% and about 3%. A cross-linking agent, such as a polyisocyanate cross-linking agent, can be incorporated into the mixture to improve the durability thereof.

In one preferred embodiment, the treatment process is conducted in several steps. First, activated carbon is impregnated with a solvent such as water, acetone, or alcohol, so that solvent molecules occupy the internal pores responsible for gas adsorption. Next, a solution or emulsion containing the fluorocarbon compound(s) is brought into contact with the activated carbon by immersion, spraying, or fluidized bed application. The fluorocarbon molecules cling to the surface of the activated carbon, since solvent molecules are blocking the internal pores. Finally, the treated carbon is dried at elevated temperatures to evaporate the solvent from the internal pores of the carbon. Typically, temperatures of about 100° C. to about 400° C. are suitable for this purpose, although temperatures of about 100° C. to about 200° C. are sufficient when water is used as the solvent.

Because the fluorocarbon treatment application is limited to the surface of the activated carbon, the adsorption properties of the activated carbon are not adversely affected. Rather, the internal pores of the activated carbon remain available for adsorption of undesirable components and the repellent finish on the surface of the carbon helps to preserve its adsorption ability.

The activated carbon, treated according to this process, has good durability, whether washed using home or industrial procedures. Even more importantly, the treatment prevents the adverse effects with respect to the durability or level of effectiveness of the activated carbon often seen with exposure of the activated carbon to laundry detergents and additives.

In addition to carbon cloth, powders, particles, granules, spheres, extruded pellets, and fibers can all be enhanced in accordance with the present treatment. Further, the activated carbon can originate from sources including, but not limited to, coconut shells, coal, wood, rayon, peat, polyacrylonitrile, phenol formaldehyde resin, and cross-linked polystyrene resin.

In creating composite 100′, textile substrates 10, 30 may be used, as well as adhesive layer 12, which have been previously described. It is believed that, in this embodiment, it is preferable to use discontinuous adhesive layers 12 to secure treated carbon cloth 22, to enhance the flexibility of composite 100′.

As before, treated textile substrate 200 and composite 100′ are positioned, with respect to one another, as shown in FIG. 2, and are sewn at least at their respective end portions. A layer of air is positioned between substrate 200 and composite 100′.

FIG. 3 shows a third embodiment of the present protective garment system. In this embodiment, the air layer is omitted from the system. Rather, treated textile substrate 200 replaces textile substrate 10. Adhesive 12 is applied to surface 204 of textile substrate 200 and the protective garment system is secured together by lamination.

In a fourth embodiment of the present protective garment system (not illustrated), the air gap between treated textile substrate 200 and composite 100 (or 100′) is held relatively constant by the addition of a spacer fabric, a thin foam layer, or other substrates that are known to those of ordinary skill in the art.

Regardless of whether the core of composite 100 or 100′ comprises carbon granules 20 or carbon cloth 22, treatment in accordance herein enhances the adsorption of the activated carbon component, when the activated carbon has been exposed to moisture. This enhancement, coupled with the ability of treated textile substrate 200 to absorb oil without oil pass-through, provides desired functionality for use of the described system as a protective garment.

1. A protective garment system, said protective garment system comprising:
an inner layer comprising a composite component, said composite component comprising a first textile component to which a first layer of adhesive has been applied, a second textile component to which a second layer of adhesive has been applied, and an activated carbon core disposed between, and adhesively bonded to, at least one of said first and second layers of adhesive;
an outer layer comprising a treated textile component, said treated textile component having a first side that is substantially hydrophobic and a second side that is at least oleophobic;
wherein said inner layer and said outer layer are joined in at least one point to form a protective garment system.

2. The protective garment system of claim 1, wherein a layer of air is disposed between said inner layer and said outer layer.

3. The protective garment system of claim 1, wherein said first layer of adhesive is a substantially continuous layer.

4. The protective garment system of claim 1, wherein said second layer of adhesive is a discontinuous layer.

5. The protective garment system of claim 1, wherein said first layer of adhesive and said second layer of adhesive are selected from the group consisting of polyurethanes, copolyamides, aliphatic polyesters, polyacrylics, ethyl vinyl acetate copolymers, and epoxies.

6. The protective garment system of claim 1, wherein said activated carbon core comprises a plurality of non-uniformly sized, non-spherically shaped carbon granules.

7. The protective garment system of claim 6, wherein said carbon granules are derived from coconuts.

8. The protective garment system of claim 6, wherein said carbon granules have sizes in the range of 12 to 80 US Mesh.

9. The protective garment system of claim 1, wherein said activated carbon core comprises a carbon material selected from the group consisting of powders, particles, granules, spheres, pellets, fibers, and cloth, said carbon material being coated with a fluorocarbon material.

10. The protective garment system of claim 1, wherein said activated carbon core comprises a carbon cloth.

11. The protective garment system of claim 1, wherein said first side of said treated textile substrate comprises a hydrophobic treatment selected from the group consisting of waxes, silicones, acrylic copolymers, polyester dispersions, polyolefin dispersions, and hydrophobically modified inorganic particulates.

12. The protective garment system of claim 1, wherein said second side of said treated textile substrate comprises at least an oleophobic treatment primarily containing a fluorocarbon.
